(19) United States
(12) Patent Application Publication
(10) Pub. No.: US 2015/0343360 A1
(43) Pub. Date: Dec. 3, 2015

(54) REGENERATIVE FILTRATION AND VOC ABATEMENT SYSTEM

(71) Applicant: PIERANGELO GHILARDI, CHARLOTTE, NC (US)

(72) Inventor: PIERANGELO GHILARDI, CHARLOTTE, NC (US)

(21) Appl. No.: 14/392,067

(22) PCT Filed: Feb. 13, 2014
(86) PCT No.: PCT/US14/16163

§ 371 Date: Aug. 10, 2015

Related U.S. Application Data
(60) Provisional application No. 61/764,576, filed on Feb. 14, 2013.

(30) Foreign Application Priority Data
Feb. 12, 2014 (US) 14179553

(51) Int. Cl. B01D 46/00; B01D 53/18; B01D 53/14

(52) U.S. Cl. CPC B01D 46/0035; B01D 53/1487; B01D 53/18; B01D 46/0057; B01D 2252/205

(57) ABSTRACT

This is a new regenerative filtration system of utility in the field of air filtering, VOC abatement, and all those fields where air filtering is suggested or required, including prep stations, spray booths and mix rooms, it is comprised of a filter unit whose orifices are permanently kept wet with an oily solution that is pumped from a container and that can be recycled, it can be used in any airflow generator and, in particular, it allows a new configuration of airflow re-generator that contains only one motor that powers one double action fan, it is cost effective, space effective and energy efficient.

### CROSS-REFERENCE TO RELATED APPLICATIONS

This application claims the benefit of provisional patent application No. 61/764,576 filed 2003 Feb. 14 by the present inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a novel design of utility in the general field of air filtration systems. The present invention is an improvement to the filtration method of the airflow generator of the Prep Paint Post of my prior U.S. Pat. No. 7,195,672 issued on Mar. 27, 2007

The present invention is an improvement to existing air filtration and VOC abatement methods.

It discloses a new Filtration arrangement that includes an impregnable, porous filter element that is constantly kept wet with an oily solution that is pumped from a container and recycled.

It provides a clean environment for the operator. It is simple to operate, cost effective, space effective, energy efficient, it reduces, and in some cases completely eliminates, VOC emissions.

### FOREIGN PATENT DOCUMENTS—REFERENCES CITED

Not Applicable

### BRIEF SUMMARY OF THE INVENTION

The present invention relates to a novel design of utility in the general field of air filtration systems, in particular to the air filtration in spray booths, prep stations and mix rooms.

Since the date of the above mentioned patent, I have been working with my system, as therein illustrated, shown and claimed, as well as observed and studied other existing solutions, and have discovered a new filtration arrangement that greatly improves filtration efficiency without affecting airflow direction, velocity and force.

The present invention greatly enhances the utility of any spray booth, prep station and mix room in terms of energy efficiency, rapidity of the job execution, and finish of the object, while drastically reducing and in some cases eliminating all VOC emissions.

The new regenerative filtration and VOC abatement system is comprised of a porous, permeable filter unit whose orifices are permanently kept wet with a liquid that is pumped from a container and recycled.

The liquid, preferably food grade Vaseline, is odor free, non toxic, resistant to high temperature.

All circulating air travels through the filters orifices and pollutants are absorbed by the liquid before the air is expelled into the atmosphere or recycled in the system.

When the liquid is saturated with pollutants, it can be disposed of properly.

The new regenerative filtration also allows for a new airflow regenerator configuration that is comprised of two main compartments. The first compartment contains one motor that powers a double action fan. The second compartment contains the new regenerative filtration system.

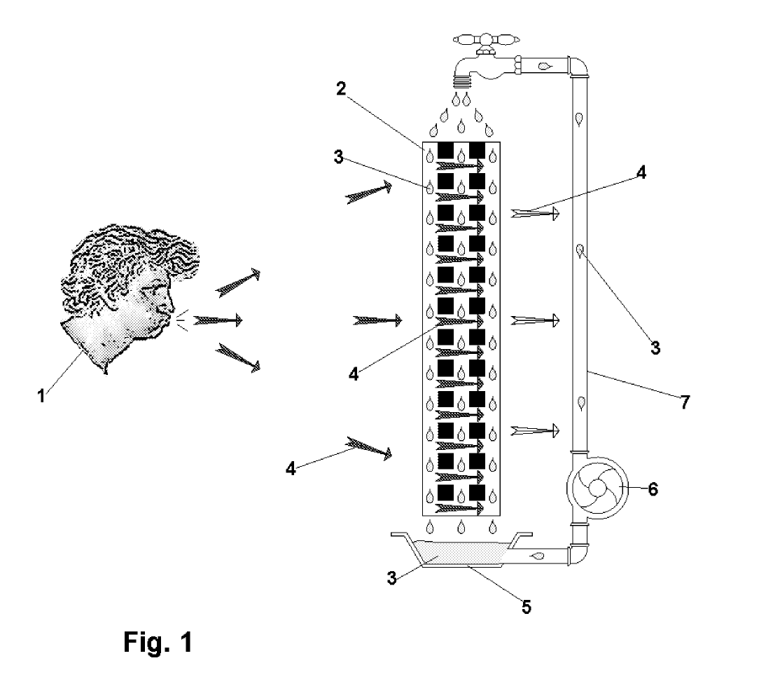

FIG. 1 shows details of a possible configuration of the regenerative filtration system with airflow direction.

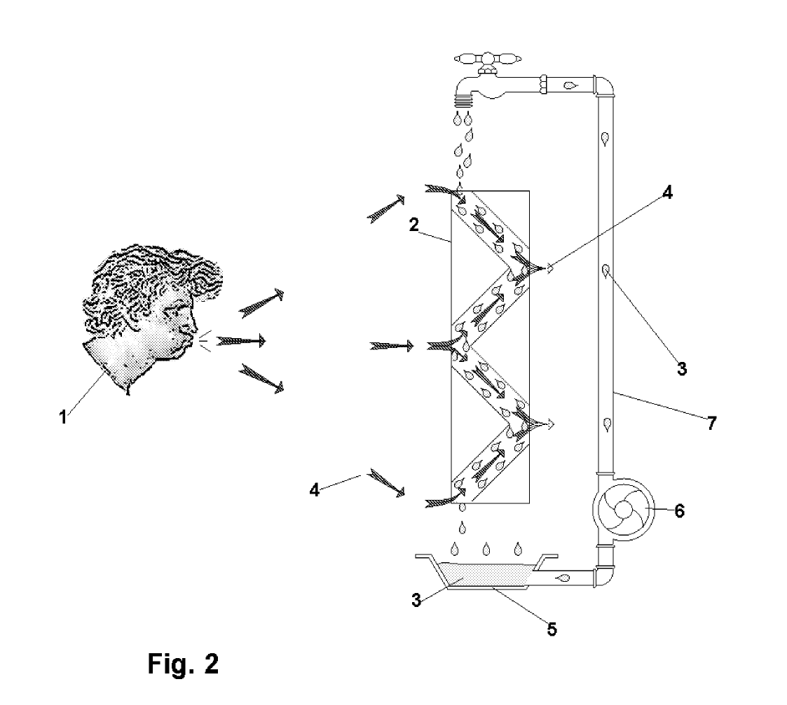

FIG. 2 shows details of a possible configuration of the regenerative filtration system with airflow direction.

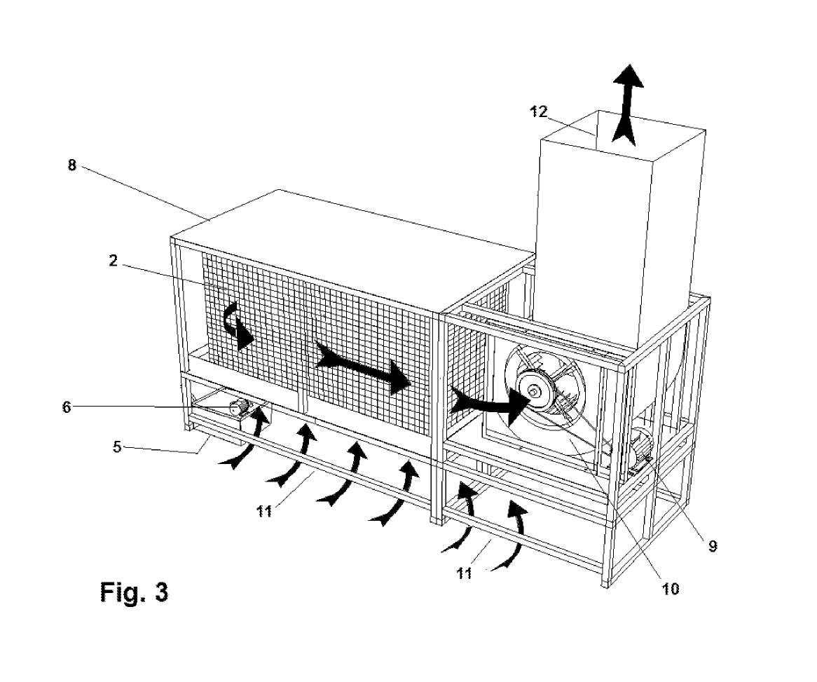

FIG. 3 shows details of a possible airflow regenerator arrangement using the regenerative filtration system with airflow direction.

DRAWING REFERENCE NUMERALS

| | | | |
|---|---|---|---|
| 1 | airflow source | 2 | filter element |
| 3 | oily solution | 4 | airflow |
| 5 | container | 6 | pump |
| 7 | oily solution duct | 8 | airflow regenerator |
| 9 | motor | 10 | fan |
| 11 | air inlet | 12 | air outlet |

### DETAILED DESCRIPTION OF THE INVENTION

The present invention relates to a system of utility in the field of prep stations, spray booths, mix rooms, and all those functions where air filtration is suggested or required.

The present invention provides a system which is easier to use for the intended purpose.

The present invention also reduces the number of parts needed for the intended purpose, in order to lower the costs and reduce the total volume of a filtration and VOC abatement system, thus allowing the realization of inexpensive, high-performing units.

The present invention also provides a simpler, more efficient combination of parts which allows the realization of a compact airflow regenerator that can be integrated in any spray booth, prep station or mix room.

The present invention also allows for a better, more uniform air circulation that maintains an even velocity, reduces static electricity, increases work area safety and

The present invention further provides a system which can be easily installed.

All these improvements, and others, of the present invention will become clear to those skilled in the art, after carefully studying the following detailed description along with the annexed drawings where the preferred embodiments of the present invention are shown only for purposes of illustration.

FIG. 1 shows a filter element 2 being kept wet with oily solution 3 by means of a pump 6 that pulls the oily solution 3 from collection container 5 and drops it on the same filter element 2 through duct 7. Airflow source 1 creates airflow 4 that passes through filter element 2 where the air is cleaned by oily solution 3.

FIG. 2 shows a different shape of filter element 2 being kept wet with oily solution 3 by means of a pump 6 that pulls the oily solution 3 from collection container 5 and drops it on the same filter element 2 through duct 7. Airflow source 1 creates airflow 4 that passes through filter element 2 where the air is cleaned by oily solution 3.

FIG. 3 shows airflow regenerator 8 where motor 9 powers a fan that draws contaminated air into the airflow regenerator through air inlet 11. Air flows through filter elements 2 that are kept wet by oily solution 3 by means of a pump 6 that pulls the oily solution 3 from collection container 5 and drops it on the same filter element 2 through duct 7, where the air is cleaned. Clean air exits airflow regenerator 8 through air outlet 12.

It should now be clear to those skilled in the art that using the Regenerative Filtration and VOC Abatement System to filter polluted air will allow for air recirculation and provide a clean environment for the operator.

Thanks to air recirculation, the present invention will also reduce the consumption of power, the number of parts needed and it will reduce the total volume of an airflow regenerator allowing for a more compact design and a better, more controlled air circulation.

Additionally, having one single motor and one single fan in the air regenerator, will maintain an even velocity of the air circulation in the system.

Moreover, using a fewer number of parts will reduce the chances of breakage and installation time.

Also, having a superior, filtered clean air gives the operator the best possible working conditions. be construed as limiting the scope of the invention, but merely to provide illustrations of some of the presently preferred embodiments of this invention. Various other embodiments and ramifications are possible within its scope. Thus the scope of the invention should be determined by appended claims and their legal equivalents, rather than by the examples given.

I claim:

1. A method for filtering polluted air by forcing said polluted air to pass through a filter element whose orifices are constantly kept wet with an oily solution.

2. A method for filtering polluted air as described in claim 1, wherein said filter element is porous and permeable.

3. A method for filtering polluted air as described in claim 1, wherein said oily solution is collected in a tank positioned at the bottom of said filter element and is pulled to the top of said filter element by means of a pump and a duct.

4. A method for filtering polluted air as described in claim 1, wherein said polluted air comes from a spray booth or a prep station or a mix room.

5. A method for filtering polluted air as described in claim 1, wherein said method is used in combination with or inside of an air generator that includes at least one motor and one fan.

6. A method for filtering polluted air as described in claim 1, wherein said oily solution is food grade Vaseline.

7. A method for filtering polluted air as described in claim 1, wherein said filter element is porous and permeable, said oily solution is collected in a tank positioned at the bottom of said filter element and is pulled to the top of said filter element by means of a pump and a duct.

8. A method for filtering polluted air as described in claim 1, wherein said filter element is porous and permeable, said oily solution is collected in a tank positioned at the bottom of said filter element and is pulled to the top of said filter element by means of a pump and a duct and said polluted air comes from a spray booth or a prep station or a mix room.

9. A method for filtering polluted air as described in claim 1, wherein said filter element is porous and permeable, said oily solution is collected in a tank positioned at the bottom of said filter element and is pulled to the top of said filter element by means of a pump and a duct and said method is one motor and one fan.

10. An air filtering system comprising:
a. a filter element,
b. a pump that pumps an oily solution to the upper part of said filter element,
c. a collection container that collects said oily solution coming out of said filter element.
d. a duct that connects said collection container to the upper part of said filter element,
whereby said filter element is constantly kept wet by said pump that pumps said oily solution to the upper part of said filter element and polluted air is forced to go through it.

11. An air filtering system as described in claim 6, wherein said filter element is porous and permeable.

12. An air filtering system as described in claim 6, wherein said polluted air comes from a spray booth or a prep station or a mix room.

13. An air filtering system as described in claim 6, wherein said air filtering system is used in combination with or inside of an air generator that includes at least one motor and one fan.

14. An air filtering system as described in claim 6, wherein said oily solution is food grade Vaseline.
